(19) United States
(12) Patent Application Publication
(10) Pub. No.: US 2012/0103146 A1
(43) Pub. Date: May 3, 2012

(54) HIGH TORQUE SCREWDRIVER

(75) Inventor: Hector Ray Hernandez, Fullerton, CA (US)

(73) Assignee: ALLTRADE TOOLS LLC, Long Beach, CA (US)

(21) Appl. No.: 12/916,047

(22) Filed: Oct. 29, 2010

(51) Int. Cl. B25B 23/16

(52) U.S. Cl. 81/450

(57) ABSTRACT

The application discloses a screwdriver that is movable from a first position to a second position. In the first position, the drive shank of the screwdriver is positioned parallel with the elongate handle. In the second position, the drive shank of the screwdriver is positioned perpendicular to the elongate handle, and is selected when additional torque must be applied to the drive shank. Structure of the screwdriver provides enhanced stability for the drive shank supported by the handle.

### BACKGROUND

The present invention relates to a tool device, and more particularly to a driver including a driving shaft rotatably attached to a handle. More particularly, the invention relates to a driver with a shaft that is either rotatable relative to the handle to a straight position in line with the handle to form a typical screw driving tool, or rotatable relative to the handle to a perpendicular position relative to the handle to form a T-shaped driving tool for allowing the tool device to be worked in different working positions.

It is well known in the prior art to provide a screwdriver in which a driving shaft is rotatable relative to a handle for facilitating a user to apply additional drive torque to the screwdriver. However, a shortcoming in prior art drivers of this type is that the connection between the driving shaft and the handle is typically flimsy and unstable. Specifically, the mechanism provided in the prior art for holding the driving shaft in a fixed alignment with the handle is typically flimsy, and may allow the alignment of the shaft to suddenly become released or disconnected from its position, and rotate to another position. This can have severely disadvantageous results, in which the user may be injured, or the work piece being worked upon may become damaged.

Thus there is a need in the art for a driver tool that overcomes these shortcomings. The present invention addresses these and other disadvantages.

### SUMMARY OF THE INVENTION

In a preferred embodiment, the present invention includes a screwdriver that is movable from a first position to a second position. In the first position, the drive shank of the screwdriver is positioned parallel with the elongate handle. In the second position, the drive shank of the screwdriver is positioned perpendicular to the elongate handle, and is selected when additional torque must be applied to the drive shank.

The preferred embodiment comprises an elongate handle, the handle defining a handle slot extending along the handle, the handle further defining a parallel stub hole and a perpendicular stub hole. A pin passes through the handle slot, the pin extending perpendicular to the handle. A drive shank is located partially in the handle slot, the shank defining an elongate shank slot, and further defining a stub at a terminal end of the shank, the stub being sized to fit snugly within the parallel stub hole and, separately, to fit snugly within the perpendicular stub hole, wherein, the pin extends through the shank slot such that the shank is configured to rotate about the pin and also to slide longitudinally in relation to the pin. Arising from this structure, the shank is configured to be moved, electively, to a first position extending parallel with the handle such that the stub is snugly positioned within the parallel stub hole, and, electively, to a second position extending perpendicular to the handle such that the stub is snugly positioned within the perpendicular stub hole. In another aspect of the invention, the screwdriver further comprises a spring positioned between the pin and the shank, the pin being configured to bias the shank away from the pin. In a preferred aspect, the shank comprises a drive shaft that defines the screw driver tip at a distal end: and further comprises a holder that defines the shank slot and defines the stub, and also defines a cylindrical opening configured to receive the drive shaft.

These and other advantages of the invention will become more apparent from the following detailed description thereof and the accompanying exemplary drawings.

### BRIEF DESCRIPTION OF THE DRAWINGS

FIG. 1 is a front view of a screwdriver, in a first position, showing features of the present invention.

FIG. 2 is a front view of the screwdriver of FIG. 1, shown in a second position.

FIG. 3 is a front sectional view of a screwdriver in a first position as seen in FIG. 1.

FIG. 4 is a front sectional view of a screwdriver in a position intermediate the first position as seen in FIG. 1 and the second position as shown in FIG. 2.

FIG. 5 is a front sectional view of a screwdriver in a second position, as shown in FIG. 2.

FIG. 6 is a side sectional view taken substantially through line 6-6 in FIG. 3.

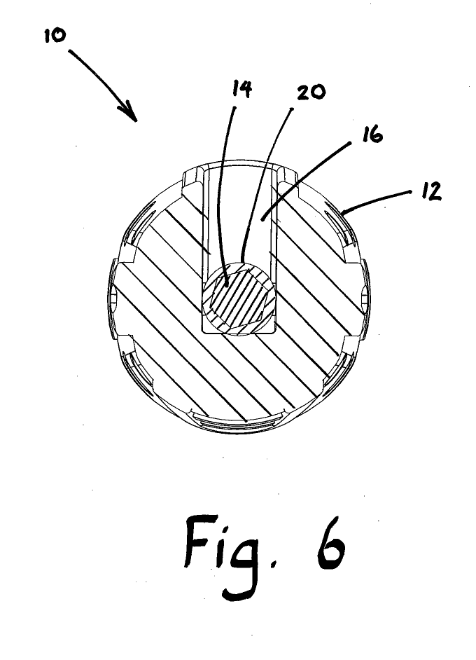

FIG. 7 is a side sectional view taken substantially through line 7-7 in FIG. 3.

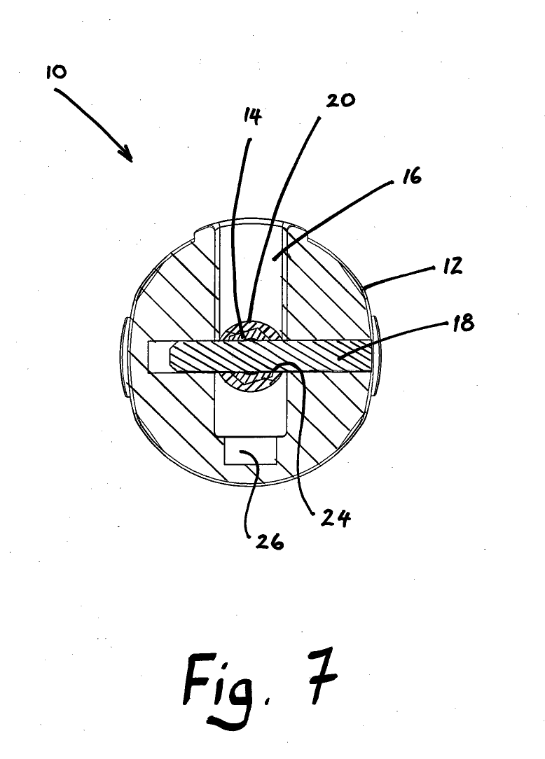

### DETAILED DESCRIPTION OF THE PREFERRED EMBODIMENTS

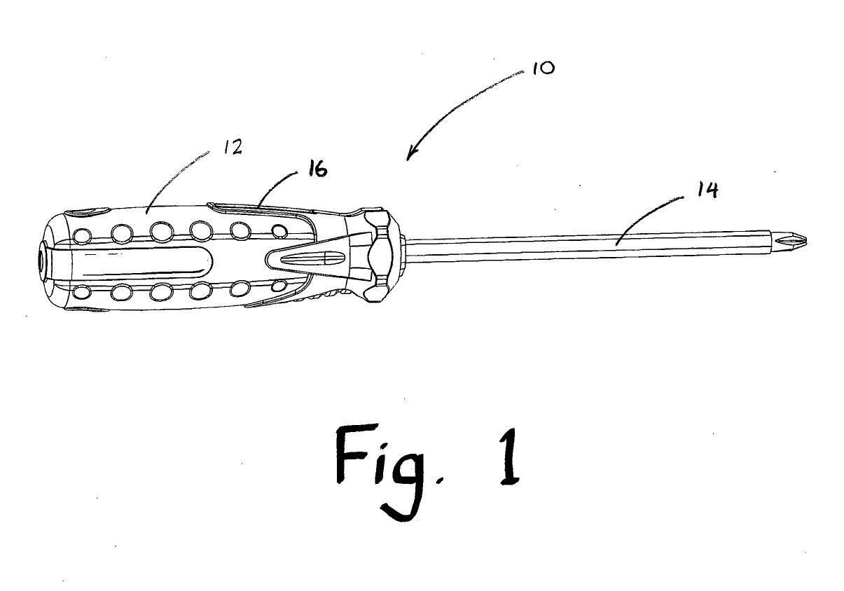

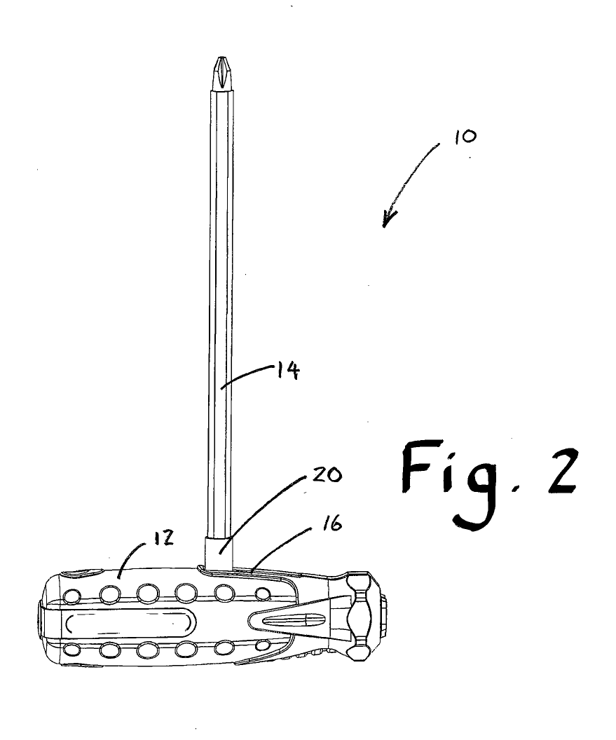

With reference to the figures, a detailed description of the preferred embodiment of the present invention is described showing a screwdriver having features of the present invention. The screwdriver 10 of the preferred embodiment has a handle 12 for applying torque to a drive shaft 14. The drive shaft 14 may extend between two positions in relation to the handle, namely a first position shown in FIG. 1, and a second position shown in FIG. 2. In the first position, the shaft 14 extends parallel with the longitudinal axis of the handle 12, and provides the shape of a regular screwdriver. In the second position, the shaft 14 extends perpendicular with the longitudinal axis of the handle 12 to provide a T-shaped connection which is useful for tasks requiring a large amount of torque to be transmitted via the shaft.

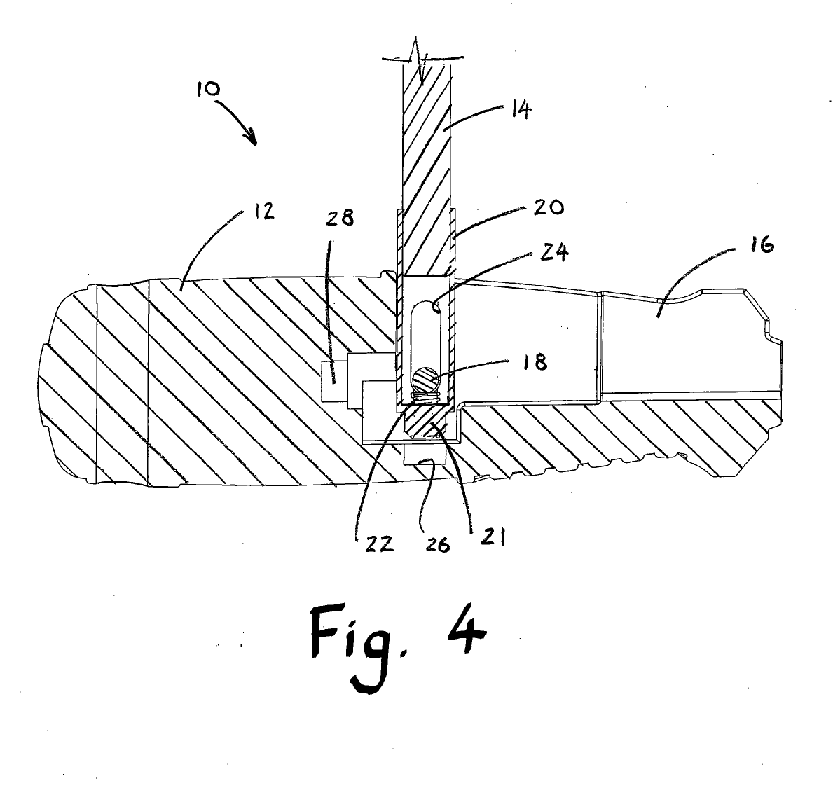

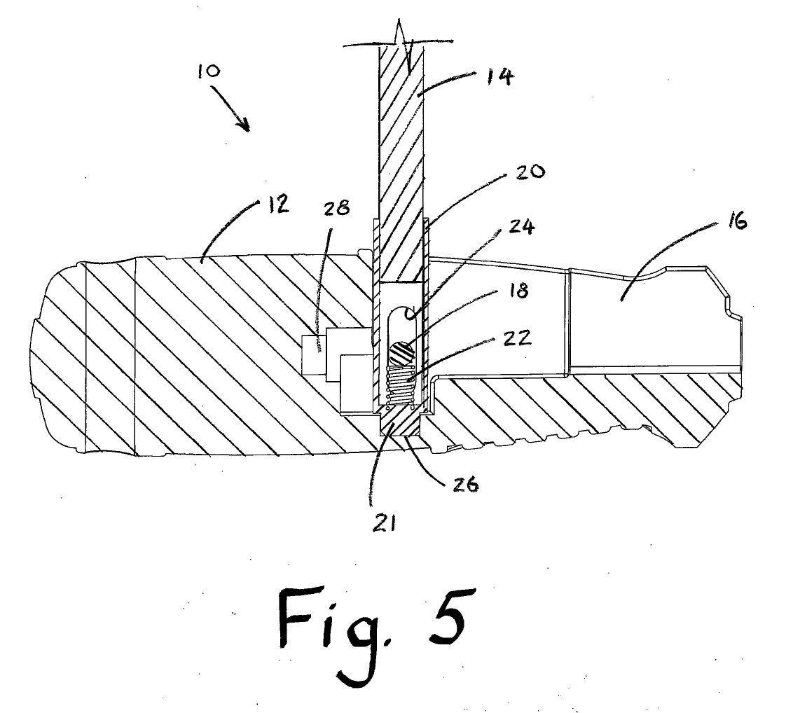

In order to support the novel features of the invention, a pin 18 is provided to extend through the handle 12. A holder 20 is positioned within the handle, is configured to rotate about the pin 18, and also to receive and capture the drive shaft 14. Importantly, the holder defines an elongate slot 24 which extends longitudinally along the holder. At a first end of the holder is a male stub 21 sized to mate with two female stub holes inside the handle. As used herein, the shaft 14 and the holder 20 are together referred to as a “shank” or “drive shank.” The pin 18 passes through the holder slot 24 to secure the holder 20 from falling out of the handle. The configuration of the holder in relation to the handle 12 and the shaft 14 permits the holder 20 two degrees of freedom. First, the holder (with shaft held in the holder) can rotate about the pin 18 thereby allowing the shaft to rotate from the first position (FIG. 1) to the second position (FIG. 2). To facilitate this rotational movement, a handle slot 16 is provided in the handle that is configured to allow the holder and shaft to pass through the handle (via the handle slot 16) between first and second positions. Second, the holder (with shaft held in the holder) can slide along the longitudinal axis of the holder in relation to the pin 18. This sliding motion will be described in further detail below, but it may be seen with reference to FIGS. 4 and 5 in which FIG. 4 shows the holder (and shaft) slid longitudinally upward in relation to the pin, and FIG. 5 shows the holder (and shaft) slid longitudinally downward in relation to the pin.

Additional components of the preferred embodiment include a spring 22 (preferably a helical spring) which is positioned inside the holder 20 to abut against the pin 18, and is configured to provide a force on the holder that biases the holder away from the pin and into the handle, in both the first and second positions. Further features of the preferred embodiment include a parallel stub hole 28 and a perpendicular stub hole 26. These two stub holes are sized to snugly receive the stub 21 of the holder, and thus to provide a detent feature between the stub 21 and the stub holes 26, 28.

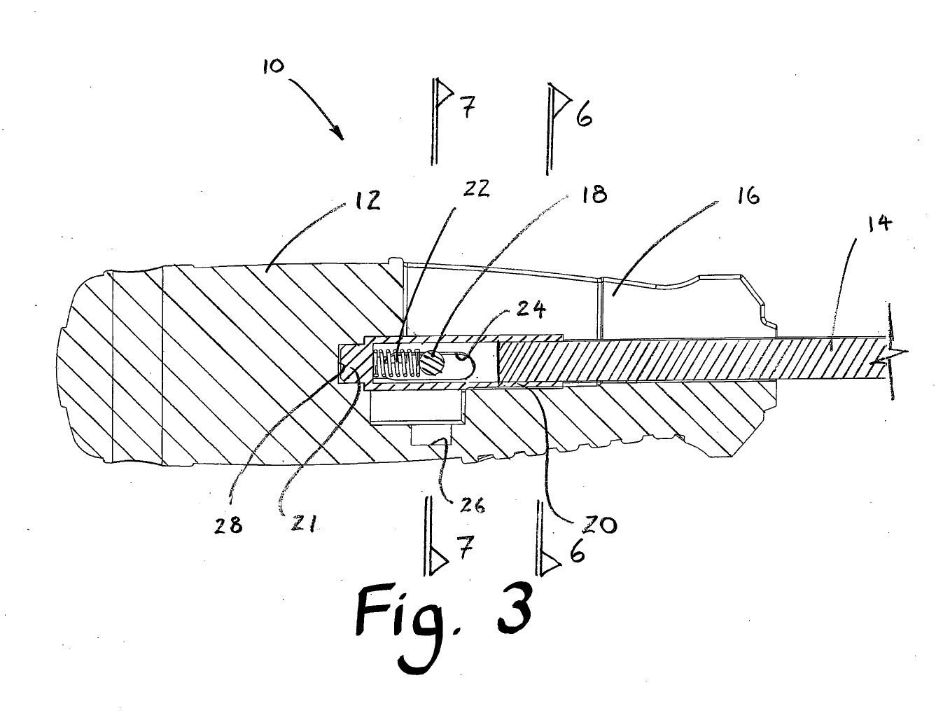

Thus, in the first position as seen in FIGS. 1 and 3, the holder 20 is biased into the handle 12 by the spring 22 so that the stub 21 is biased towards and fits snugly into the parallel stub hole 28. Thus, the holder 20 is provided with resistance against rotation in relation to the handle by a couple provided a contact between the stub 21 and parallel stub hole 28, and contact between the pin 18 and holder slot 24. These two contact points along the shank separated from each other by a lever arm of about one half to one inch, and prevent the shaft from rotating away from the first position in relation to the handle during use.

In the second position as seen in FIGS. 2 and 5, the holder is biased across the handle 12 by the spring 22 so that the stub 21 is biased towards and fits snugly into the perpendicular stub hole 26. Thus, the holder 20 is provided with resistance against rotation in relation to the handle by a couple provided by a contact between the stub 21 and perpendicular stub hole 26, and contact between the pin and holder slot. These two contact points are likewise separated from each other by a lever arm of about one half to one inch, and prevent the shaft from rotating away from the second position in relation to the handle during use.

Furthermore, when the stub 21 of the holder 20 is positioned in one of the stub holes 26, 28, the holder is provided with a bias by the spring 22 against popping out of either stub hole, thereby ensuring an advantageously safe working condition.

In use, the screwdriver of the present invention is configured to operate as follows. Taking the screwdriver in its first position (FIGS. 1 and 3) the user may apply torque to a work piece (not shown). If the user determines that he requires greater torque than he can generate with the screwdriver in the first position, he pulls the shank (i.e. the shaft 14 along with the holder 20) longitudinally out of the handle against the bias of the spring 22 so that the spring 22 becomes compressed against the pin 18. He then rotates the shaft in relation to the handle by passing it through the handle slot 16 until it reaches a position that is perpendicular to the handle, as exemplified in FIG. 4. It will be seen in FIG. 4 that the spring 22 is still in the compressed condition. The user then either lets go of the shank thereby allowing the spring 22 to push the shaft into the handle, and thus allowing the pin 18 to slide within and relative to the holder slot 24 so that the stub 21 of the holder 20 snugly enters the perpendicular stub hole 26 where it is held securely with a détente action. In this second position, the shaft 14 is held securely against rotation in relation to the handle 12, and the user may apply the required degree of torque to the work piece (not shown.).

Once this application of torque is complete, and in reverse, the user may then pull the shaft from its second position (FIG. 5) against the bias of the spring 22, to compress the spring 18, and withdraw the stub 21 from the perpendicular stub hole 26 (as seen FIG. 4). The user then rotates the shaft to align the shaft with the handle (by passing the shaft through the handle slot 16), and then allows the spring 22 to bias the shaft into the handle so that the stub 21 snugly enters the parallel stub hole 28 to secure the shaft and holder in the first position, as seen in FIG. 3. Naturally, in either case, the user may assist the spring 22 bias by pushing the shank with his hand in the desired assisting direction, either horizontally or perpendicularly.

The resulting structure provides a stable couple to hold the shank in both the first and second positions, and allows a user to easily adjust the shank from the first to the second positions by merely pulling the shank out of its first restrained position, rotating the shank, and inserting the shank into a second restrained position that is perpendicular to the first, and then to reverse the process when desired. The large restraining couple lever arm allows for stabilizing forces internal to the handle of the screwdriver that are much smaller than forces that are generated in mechanisms of the prior art configured to hold a shank in a stable position against rotation. With smaller restraining forces in the present invention, the handle and its restraining mechanism have a prospect of a longer user life than screwdrivers in the prior art that are configured to adjust between two perpendicular positions.

Thus, there has been described a configuration for a screwdriver that overcomes shortcomings in the prior art. The present invention may, of course, be carried out in other specific ways than those herein set forth without departing from the essential characteristics of the invention, which is set forth in the claims below.

I claim:

1. A screwdriver comprising:
an elongate handle, the handle defining a handle slot extending along the handle, the handle further defining a parallel stub hole and a perpendicular stub hole;
a pin passing through the handle slot, the pin extending perpendicular to the handle;
a drive shank located partially in the handle slot, the shank defining an elongate shank slot, and further defining a stub at a terminal end of the shank, the stub being sized to fit snugly within the parallel stub hole and, separately, to fit snugly within the perpendicular stub hole, wherein, the pin extends through the shank slot such that the shank is configured to rotate about the pin and also to slide longitudinally in relation to the pin;
wherein, the shank is configured to be moved, electively, to a first position extending parallel with the handle such that the stub is snugly positioned within the parallel stub hole, and, electively, to a second position extending perpendicular to the handle such that the stub is snugly positioned within the perpendicular stub hole.

2. The screwdriver of claim 1, further comprising a spring positioned between the pin and the shank, the pin being configured to bias the shank into the handle.

3. The screwdriver of claim 1, wherein the shank comprises:
a drive shaft that defines the screw driver tip at a distal end: and
a holder that defines the shank slot and defines the stub, and also defines a cylindrical opening configured to receive the drive shaft.
